(19) United States
(12) Patent Application Publication
(10) Pub. No.: US 2006/0076152 A1
(43) Pub. Date: Apr. 13, 2006

(54) Travelling soil cultivation appliance, especially a lawnmower

(75) Inventors: Reiner Haufele, Laupheim (DE); Wolfgang Lindermeir, Untermarchtal (DE); Ulrich Schaub, Ulm (DE)

Correspondence Address: AKERMAN SENTERFITT, P.O. BOX 3188, WEST PALM BEACH, FL, 33402-3188, US

(73) Assignee: GARDENA Manufacturing GmbH, Ulm (DE)

(21) Appl. No.: 11/220,088

(22) Filed: Sep. 6, 2005

Related U.S. Application Data
(63) Continuation-in-part of application No. 10/467,030, filed on Aug. 1, 2003.

(30) Foreign Application Priority Data
Mar. 2, 2001 (DE) 101 05 005.4

(51) Int. Cl. A01B 15/12

(52) U.S. Cl. 172/329

(57) ABSTRACT

A soil cultivation appliance, especially a lawnmower, which can be motor-driven or manually driven. The appliance is provided with a steering shaft and a steering frame or wheel for the operator. The steering device enables the soil cultivation appliance to change direction due to the fact that torque is introduced into the housing of the soil cultivation appliance by the steering shaft. The torque is used to change the direction of the advancing movement, to the left or to the right, without needing to steer the wheels. An advantage of the appliance is that, when the steering shaft is arranged on the housing in a continuously pivotable manner, the position of the operator is independent from a thrust frame or the like, by which means the soil cultivation appliance must be mechanically guided.

### CROSS-REFERENCE TO RELATED APPLICATIONS

This application is a continuation-in-part application to U.S. patent application Ser. No. 10/467,030, filed Aug. 1, 2003, which formed the national phase of PCT Patent Application No. PCT/EP02/01059, filed Feb. 1, 2002, and which claimed the benefit of German Patent Application No. 10105005.4, filed Mar. 2, 2001. The entire contents of U.S. patent application Ser. No. 10/467,030 are incorporated herein by reference.

### BACKGROUND OF THE INVENTION

The invention relates to a traveling soil cultivation appliance, particularly a lawnmower having a housing for receiving the cultivating elements and with a guide device which can be handled by an operator and which is pivotably arranged on the housing with respect to an axis substantially vertical to the cultivating plane.

Traveling lawnmowers normally have a thrust frame as the guide mechanism, which is firmly positioned on the housing by means of two legs. The housing generally has four wheels, which are in each case arranged pairwise on a front and a rear wheel axle. The front wheels can also be replaced by a single, central front wheel. Such lawnmowers are advanced either by a motor drive of the rear wheels or by the operator by means of the thrust frame, which is fixed to the lawnmower casing. The thrust frame is also used for steering the mower by lateral pressure and/or by raising non-pivotable front wheels from the ground. Such lawnmowers or other soil cultivation appliances suffer from the disadvantage that steering and guidance of the appliance is only possible when the operator is in front of or, if the thrust frame is positioned in pivotable manner, behind the lawnmower. If it is necessary to deal with obstacles such as e.g. overhanging bushes, guidance becomes difficult or impossible.

A lawnmower with a pivotable guide frame is known (DE-OS 2 448 129), in which the guide frame is so articulated to a ring rotatable with respect to the mower housing that it is pivotable about the rotation axis of the ring in 90° stages and about its horizontal articulation axis up to an angle of 180°. This design permits an orientation of the thrust frame in a direction perpendicular to the direction of travel. However, the desirable guidance from intermediate positions is impossible.

Therefore a problem addressed by the present invention is to so design a soil cultivation appliance, particularly a lawnmower of the aforementioned type that guidance and steering are possible from all positions.

### SUMMARY OF THE INVENTION

In the case of a soil cultivation appliance of the aforementioned type, this problem is solved in that the guide mechanism is provided with a rotary steering device, whose rotary movement at or in the housing can be converted into a torque about a vertical axis. Therefore the possibility of steering the soil cultivation appliance which has hitherto only been possible by means of a thrust frame acting externally on the housing has now been modified in such a way that the torque exerted by the operator on a steering device is transmitted as a torque exerted on the housing of the soil cultivation appliance or lawnmower. The guide mechanism can therefore be designed so as to be freely movable about the axis vertical to the cultivation plane, because, unlike in the case of known constructions, it does not directly serve as a lever for exerting steering forces.

According to an embodiment of the invention, the steering device can comprise a steering shaft with a steering wheel facing an operator or a steering frame. The steering shaft is advantageously constructed as a telescopic shaft, which also makes it possible to guide the cultivation appliance from to a certain extent differing distances.

According to a further embodiment of the invention, the steering shaft can be oriented under a predetermined angle to the cultivation plane and on the housing can be fitted to a bearing body, which is pivotably mounted about the vertical axis in the housing. Unlike in the case of the aforementioned, known construction, in which the pivotable ring on which the thrust frame is located must be firmly lockable in positions displaced by in each case 90° in order to permit guidance by means of the thrust frame, the bearing body can be positioned in a freely movable manner, because it does not serve as an element with which a torque must be transmitted. Thus, the steering shaft can be guided from different positions with respect to the housing of the lawnmower or the like, which significantly improves the cultivation possibilities.

In another embodiment of the invention, the steering shaft can traverse the bearing body and act with at least one offset on a support surface of the housing, which is located at least in a direction parallel to the cultivation plane spaced from the bearing body. This makes it possible to exert lateral or component forces on the housing of the soil cultivation appliance which, since their application points in the longitudinal direction of the housing differ, exert a torque on the housing for guidance purposes.

According to a further embodiment of the invention, the support surface can be part of a guide casing for the bearing body firmly held in the housing and which forms a shaft with side walls oriented parallel to the direction of travel of the soil cultivation appliance and which serve as support surfaces. Such a design allows a pivoting of the steering shaft about the vertical axis and whilst the offset thereof admittedly comes to rest at different locations, it always engages on the shaft side walls and consequently makes it possible to exert the necessary steering forces.

In an embodiment advantageous because of its great simplicity, the offset of the steering shaft can be constructed as a laterally projecting arm provided at its free end with a slider guided on both side walls of the shaft. This design ensures that in all pivot positions of the steering shaft the slider exerts lateral forces in one or other direction on the housing, which lead to the desired steering torque with the opposing forces exerted by the counterbearing of the steering shaft in the bearing body.

The hitherto described designs according to the invention provide a steering shaft, which is oriented under a predetermined, fixed angle with respect to the cultivation plane. However, it is also possible to fit the steering shaft part traversing the bearing body on the bearing body side directed towards the operator in articulated manner on the further part of the steering shaft and this can e.g. take place by means of a universal joint. With such an embodiment, the steering shaft is freely movable about the vertical pivot axis of the bearing body, but is also pivotable, at least to a certain extent, relative to the soil cultivation plane, so that the guidance and cultivation possibilities are further extended. The steering shaft held by the operator can consequently be held higher or lower with respect to the ground.

According to another embodiment, which allows a certain height change when handling the steering shaft, the steering shaft is provided at the end facing the housing with a bevel gear, which cooperates with a corresponding toothed disk fixed to the housing. Also in the case of such an embodiment, where naturally there is also a pivotability about the vertical axis, the steering shaft can be raised or lowered to a certain extent without the guidance function being lost.

In a further embodiment of the invention, the steering shaft can be constructed as a flexible shaft, which can e.g. be guided in a support body pivotable about a vertical axis. A design where the soil cultivation appliance is appropriately motor-driven is possible according to the invention because the torque for steering the soil cultivation appliance is not exerted by means of a lever action of a thrust frame or the like. Tests have shown that with the novel design according to the invention there is a completely satisfactory guidance-steering possibility for the soil cultivation appliance or lawnmower. It has been found to be particularly appropriate if the housing is provided with front and rear wheels, the vertical axis about which the torque is exerted is positioned between the front and rear wheels and the spacing of the vertical axis in the housing longitudinal direction is less than 30% of the spacing between the front and rear wheel axes.

It is also possible to provide one or two casters on the front wheel arrangement. However, it has been found that excellent steering possibilities also exist if the wheel arrangements are not steerable and the contact surfaces of the wheels have a limited sliding resistance with respect to lateral displacement.

Embodiments with a rigid or also a length-blockable telescopic shaft as the steering shaft also permit the advance of the soil cultivation appliance or lawnmower through manual pushing by an operator.

The guidance mechanism can finally be fitted in removable manner to the housing in order to render more compact for transportation or storage purposes the soil cultivation appliance or lawnmower.

### BRIEF DESCRIPTION OF THE DRAWINGS

The invention is described in greater detail hereinafter relative to embodiments and the attached drawings, wherein show:

FIG. 1 plan view of a lawnmower according to the invention having a housing with four wheels.

FIG. 2 variant of the embodiment of FIG. 1 with a different front wheel design.

FIG. 3 side view of the lawnmower of FIG. 1.

FIG. 4 diagrammatic representation of the lawnmower according to FIGS. 1 and 3 in a plan view during cornering.

FIG. 5 diagrammatic partial view of a steering device according to the invention in a modified embodiment compared with FIGS. 1 to 4.

FIG. 6 perspective view of another embodiment of a lawnmower.

FIG. 7 larger-scale partial representation of a section along plane VII in FIG. 6 in the steering shaft application area.

FIG. 8 plan view of the guide casing shown in part sectional form in FIG. 7.

FIG. 9 perspective side view of the guide casing according to FIGS. 7 and 8.

FIG. 10 is a perspective view of a lawnmower according to an alternative embodiment.

FIG. 11 is a side view of the lawnmower of FIG. 10.

FIG. 12 is an enlarged, part-sectional view of the universal joint of the lawnmower of FIG. 10.

FIG. 13 is an enlarged, part-sectional view of the buckling joint of the lawnmower of FIG. 10.

### DETAILED DESCRIPTION OF THE INVENTION

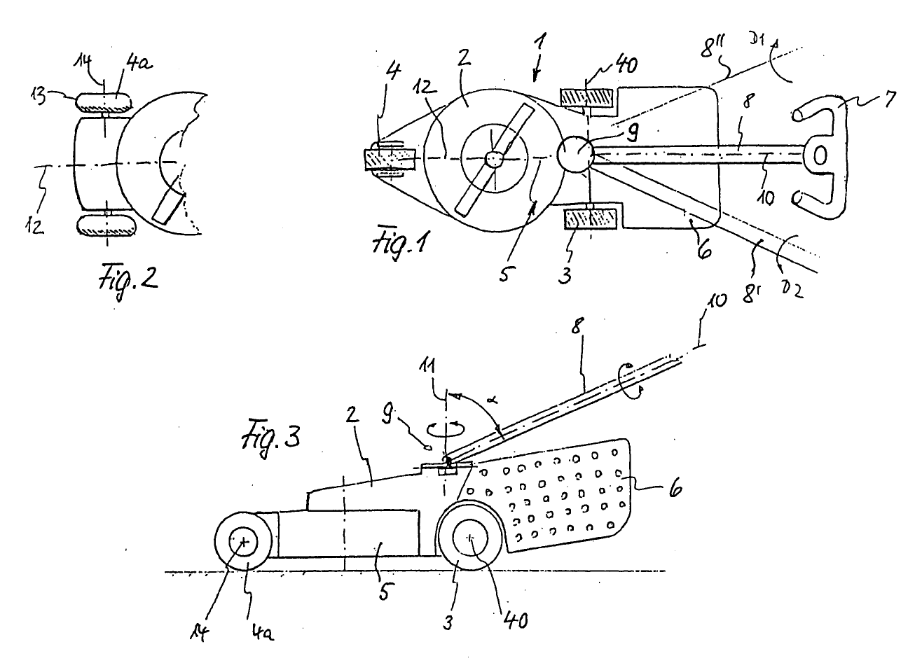

The lawnmower 1 shown in FIGS. 1 and 3 has a housing 2, which is able to travel on two rear wheels 3 with aligned wheel axes or axles and a front wheel 4, which can e.g. be constructed as a caster freely pivotable about a vertical axis. Between the rear wheel axis 40 and the front wheel 4 the motor and blade 5 are located inside the mower housing 2. A cut material collector 6 is provided at the rear end of the mower, facing the user.

The user moves the lawnmower by means of a guidance mechanism, which in the embodiment shown comprises a user-side gripping frame 7 and a steering shaft 8 leading from the latter to the mower housing 2. The steering shaft 8 is articulated to the mower housing 2 in a steering mechanism 9 and rotatable about its longitudinal axis 10. The gripping frame is connected to rotate with the steering shaft. The steering mechanism 9 is designed in such a way that a rotation of the steering shaft 8 about its longitudinal axis 10 is coupled with a pivoting of the orientation of the steering gear about a substantially vertical pivot axis 11 in the steering mechanism 9 relative to the mower housing. As a result of said coupling, a torque exerted by an operator by means of the gripping frame 7 about the longitudinal axis 10 of the steering shaft 8 in the steering mechanism 9 is converted into a torque about the vertical pivot axis 11 acting on the mower housing 2.

With such an arrangement, the operator can pivot the steering shaft 8 about the vertical pivot axis 11 and can take up a position laterally displaced against the mower longitudinal axis 12 and without changing his own position by exerting a torque by means of the gripping frame 7 on the steering shaft 8 can pivot the mower housing 2 relative to said steering shaft about the vertical pivot axis 11. In plan view, the pivot axis 11 is advantageously slightly spaced from the rear axis or axle 40. The horizontal spacing of the pivot axis 11 from the common rear axis 40 of the rear wheels 3 is preferably less than 30%, particularly less than 20% of the horizontal spacing of the front wheel 4 from the rear axis 40. On exerting a torque in this way, the mower housing 2 is pivoted about the pivot axis 11 relative to the operator until the desired orientation is obtained.

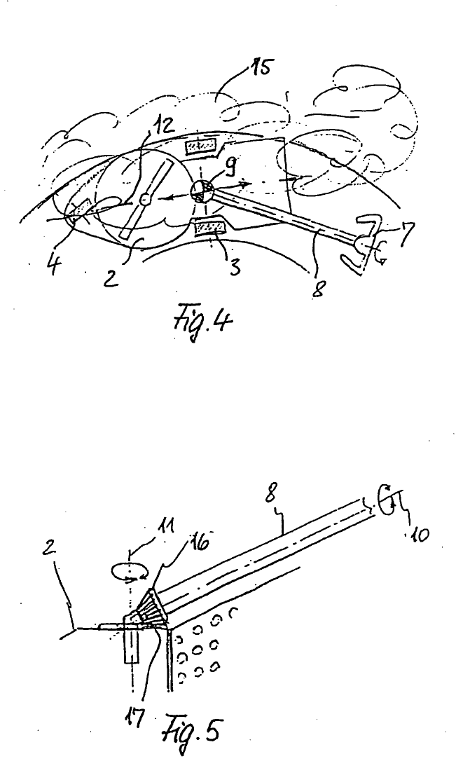

The resistance to the orientation change is particularly low when using a pivotable caster 4 as the front wheel and this also applies in the same way for a pair of casters as laterally spaced front wheels. It has surprisingly been found that front wheels 4a running on rigid axles 14, as shown in the front part of a mower in FIG. 2, also allow such a mower housing pivoting, particularly if such rigidly oriented wheels 4a are slightly profiled or completely smooth and have clearly arcuate or arched contact surfaces 13. It is obviously possible to have a single front wheel with a rigid wheel axle.

FIG. 1 shows the starting positions of the steering shaft 8 with continuous lines and two laterally pivoted orientations 8′, 8″ of the steering shaft corresponding to opposing rotations D1, D2 of the steering shaft about its steering axis by means of broken lines.

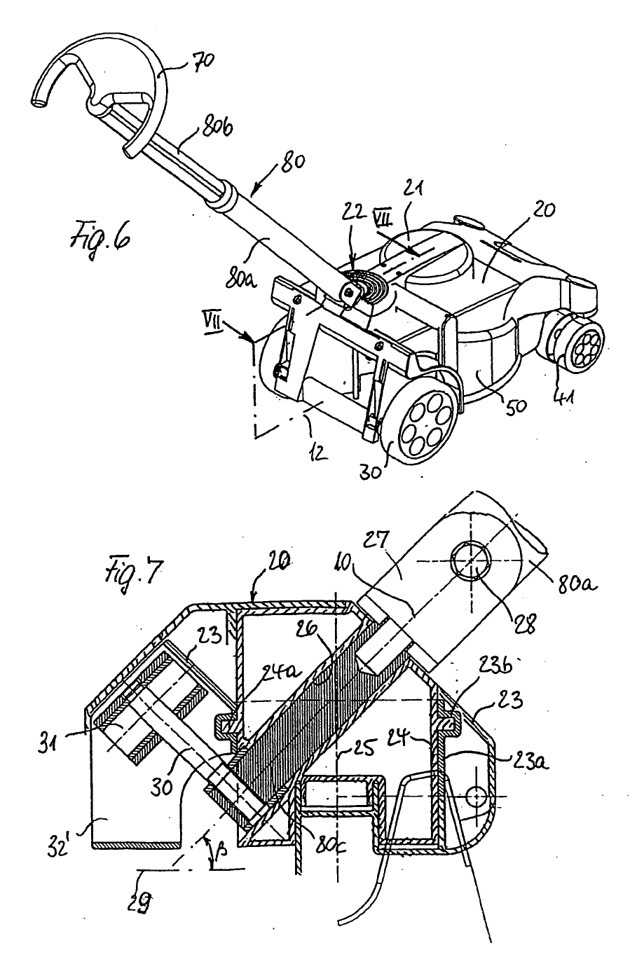

FIG. 4 illustrates a situation where the mower housing is guided on a curved path with the operator position laterally displaced with respect to the longitudinal axis 12 and which as a result can e.g. be easily used under a bush 15 or some other difficultly accessible location.

According to the variant of FIG. 5, the steering mechanism 9 contains a bevel gear transmission with a bevel gear 16 rotatable with the steering shaft about its longitudinal axis and a gear rim or partial gear rim 17 on the side of the mower housing 2. Another variant of the steering mechanism can have a universal joint, particularly an offset universal joint, a ball end joint or some other joint transmitting torque with angular displacement. In the case of the variant with a bevel gear transmission 16, 17, the inclination angle of the longitudinal axis 10 of the steering shaft 8 shown in side view in FIG. 3 is typically fixed with respect to the vertical pivot axis 11 or can only be modified to a limited extent, whereas in the case of the variant of a steering mechanism with a universal joint said angle can be modified over a larger, but still limited range.

It is common to the embodiment shown that the torque axis 10 of the torque exerted by the user on the gripping frame does not coincide with the torque axis 11 of the torque acting on the mower housing. The mower can be self-propelled or also pushed.

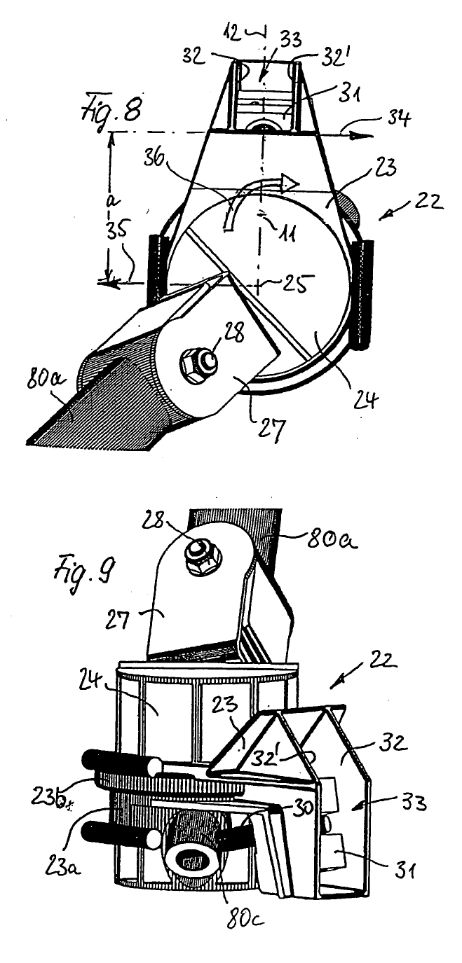

The length of the thrust frame arrangement is preferably variably adjustable, which in particular, as will be explained relative to FIG. 6, can in advantageous manner be implemented by constructing the steering shaft 8 as a telescopic tube.

FIG. 6 shows a lawnmower having a traveling housing 20 with in each case front wheels 41 and rear wheels 40 and which in similar manner to the embodiment of FIGS. 1 and 3 is equipped with a motor and a blade casing part 50. On its top surface the housing 20 is provided, in addition to a lid 21 giving accessibility to the drive motor, with the cover 22 visible in FIG. 6 for a guide casing 23 used for receiving the steering shaft 80 and which her comprises two telescopically guided parts 80a and 80b. On part 80b is located a steering wheel 70 by means of which an operator, in much the same way as in the embodiment of FIGS. 1 and 3, can exert a steering torque on the lawnmower housing 20.

The guide casing 23 is located in fixed manner in the interior of the housing 20 and which comprises, a shown in FIGS. 7 to 9 a casing part firmly inserted in the housing 20 and in which is held a roughly cylindrical bearing body so as to rotate about axis 25 as a result of the fact that it is inserted in a corresponding cylindrical guide 23a of the guide casing 23 and is held with a flange 24a in a corresponding annular groove 23b of the guide casing. In the embodiment, the bearing body 24 is provided with a cylindrical guide 26 inclined by an angle to a plane 29 and in which is inserted the cylindrical end of the steering shaft 80. In this embodiment, the steering shaft part 80a is not constituted by a continuous, one-piece shaft part, but instead by the end piece 80c, which runs coaxially to the steering axis 10 in guide 26 and a link plate 27 connected to rotate with said shaft end 80c and in which with the aid of a tie bolt 28 the shaft part 80a is inserted in removable manner, but aligned with the shaft axis 10. The shaft part 80a with the shaft part 80b displaceably held therein and the steering wheel 70 is therefore arranged in removable manner, so that the lawnmower is not too bulky and does not take up too much space for transportation or storage purposes.

In the free end portion of the shaft end 80c is inserted an arm 30 in the form of a bolt projecting perpendicularly to axis 10 and which is in turn provided at its free end with a slider 31 held in rotary manner thereon. The slider 31 engages on the lateral surfaces 32 and 32′ of a shaft 33, which is fitted in one piece on the guide casing 23 and extends with its parallel side walls 32, 32′ over a height sufficiently great to ensure the engagement of the slider 31 in all pivoting positions of the steering column 80 within the shaft 33 and the corresponding displacement movement of the slider within the shaft 33.

As can be gathered from FIGS. 6 to 9, the exerting of a torque on the steering wheel 70 consequently brings about a torque in the shaft 80. The end piece 80c of the steering shaft 80 then attempts to pivot the arm 30 in one or other direction. However, the slider 31 of arm 30 is guided in firmly engaging manner on the lateral surfaces 32, 32′ of shaft 33, so that e.g. on exerting a clockwise torque (FIG. 8), the slider 31 is pressed against side wall 32′ and consequently exerts a lateral force in the direction of the arrow 34 on the guide casing 23 and, as the latter is firmly located in the housing 20, also on the latter. The opposing force resulting from the exerting of said force in the direction of the arrow 34 by means of the steering shaft part 80c is supported in the bearing body 24, which in turn presses in the opposite direction to the force according to arrow 34 against its guide casing 23 and consequently exerts a force in the direction of arrow 35 on the guide casing and on housing 20. Both forces acting in the direction of arrows 34 and 35 consequently bring about a torque on the housing 20 in the direction of the arrow 36, which acts about the vertical axis 11 and in the same way as has been described relative to the embodiment of FIGS. 1 to 3 can be utilized for guiding the lawnmower.

It is immediately clear that it is not a matter of an orientation of the steering shaft 80 inclined by an angle with respect to the cultivation surface in the direction of travel, i.e. in the direction of the longitudinal axis 12 or the sectional plane VII in FIG. 6. As is also shown in FIG. 1, the steering shaft 80 can be inclined to said longitudinal axis 12 and can also be pivoted with respect thereto during the cultivation process. This merely brings about a displacement of the slider 31 within the shaft 33, but does not prejudice the action of the steering process.

Here again it is appropriate for the contact surfaces of the wheels 41 and optionally also the wheels 30 to have a minimum sliding resistance. However, it has been found that this is not absolutely necessary and that a torque applied by means of the steering wheel 70 can be sufficient to bring about the desired cornering of the lawnmower.

It would also be possible to use in place of the steering shaft 80, which has a rigid construction transversely to its longitudinal axis 10, to use a flexible shaft by means of which the desired torque can be introduced into the housing 20. It is also possible not to provide the steering shaft 80 with the projecting arm 30 as an offset and instead to equip it within the housing 20 with at least one offset, which in the same way as in the embodiment shown exerts a lateral force in one direction on the housing 20 and in the longitudinal direction of said housing 20, i.e. in the direction of the longitudinal axis 12, and in displaced manner with respect thereto brings about an opposing force in the opposite direction, which once again is used for producing the desired torque on housing 20.

The novel manner of steering a soil cultivation appliance consequently allows the continuous position change of an operator with respect to the appliance, without thereby impairing the steerability of said appliance.

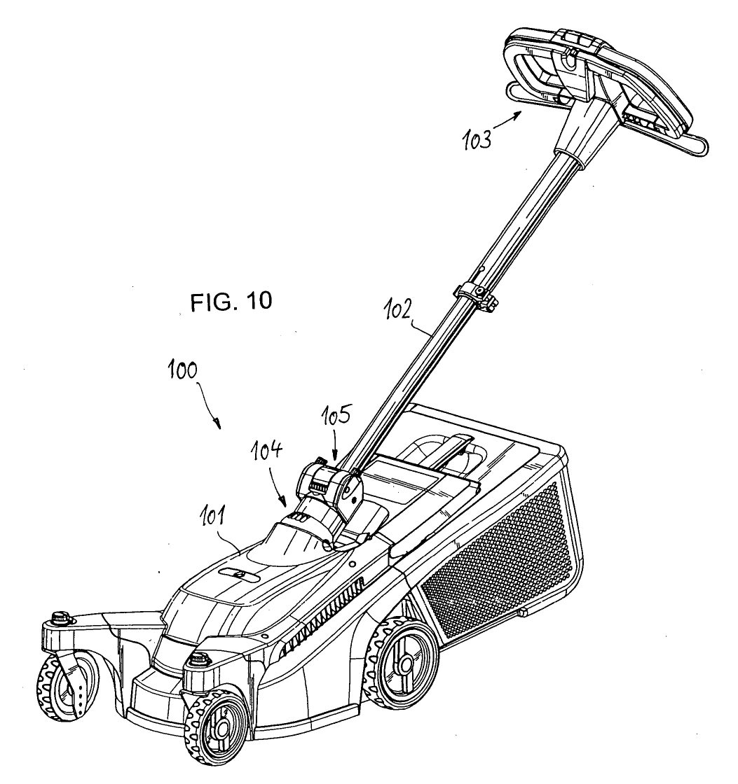

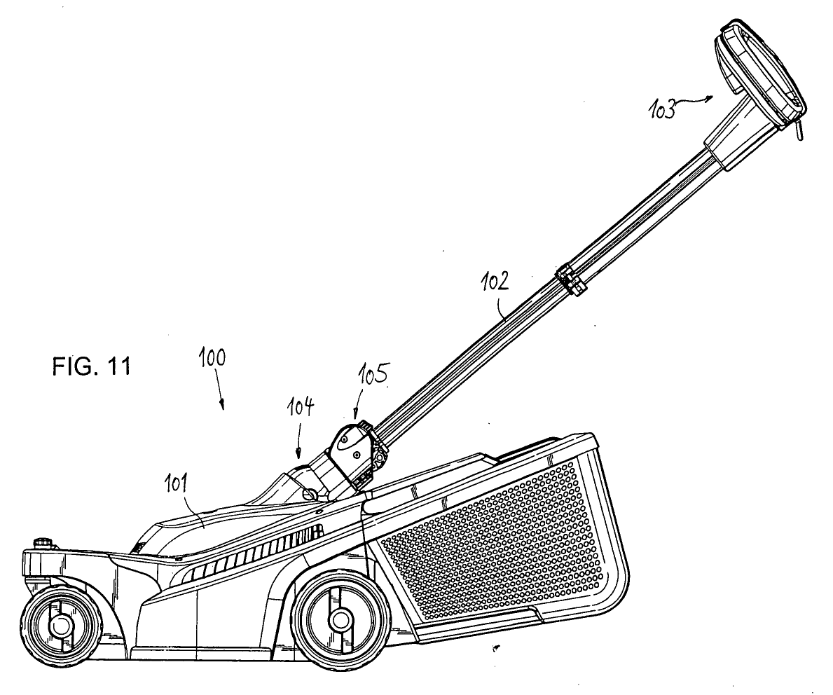

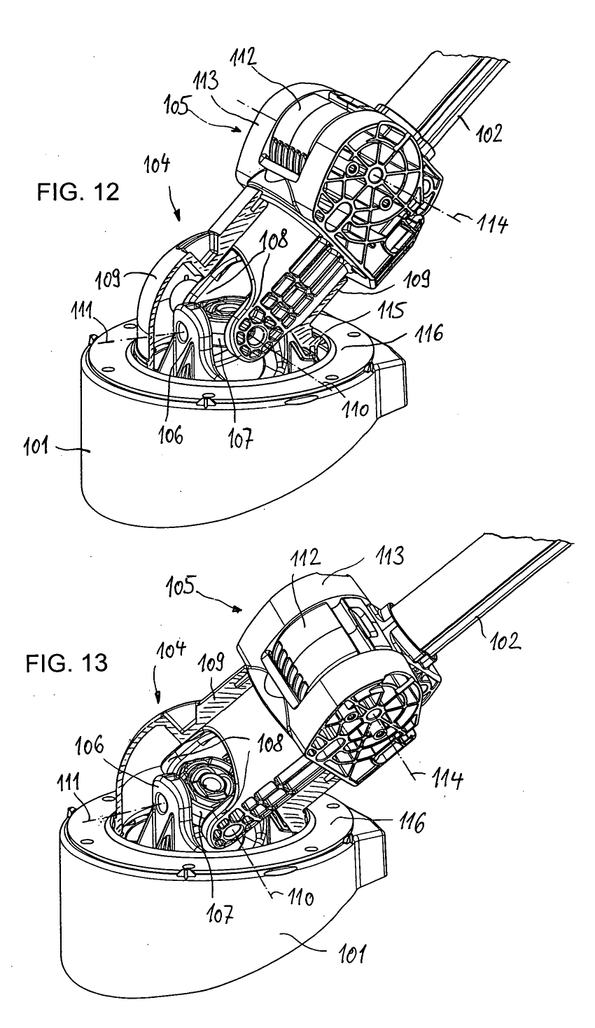

FIGS. 10 and 11 illustrate an alternative embodiment of lawnmower according to the invention, and which give an overall view of the position of the steering mechanism formed by a universal joint 104 and a buckling joint 105. FIGS. 12 and 13 show in an enlarged scale the universal joint and the buckling joint in part-sectional form. In order to clearly show the inner details of the universal joint, the dome-like hollow body 109 is shown partially cut off.

As can be seen from FIGS. 12 and 13, the steering shaft 102 has at its lower end the buckling joint 105 which is extended in a joint shank 108, which is part of the cardan or universal joint 104. The joint shank 108 is pivotably connected to a central cardan element 107 around a transverse pivot axis 110. The central cardan element is provided as a ring-like element. It could, however, be constructed as a cross-like element. The central cardan element 107 is pivoted in a stationary joint shank 106 around a longitudinal pivot axis 111 which is extended along the longitudinal axis of the housing 101 and, therefore, of the lawnmower. The longitudinal pivot axis 111 can be inclined to some degree in a vertical plane which contains the longitudinal axis of the housing 10, and remains stationary during use. In a preferred arrangement, the longitudinal pivot axis 111 of the cardan joint is extended in an essentially horizontal arrangement, most preferably in the driving direction. The transverse pivot axis 110 is perpendicular to the longitudinal pivot axis 111. The stationary joint shank 106 is positioned stationary to the housing 101 and could be a one-piece part of the housing.

The lower end of the steering shaft 102 which ends in the joint shank 108 is surrounded by a cylindrical hollow part of the dome-like support element 109 so that the cylindrical end of the steering shaft 102 is rotationally or pivotably guided by this cylindrical hollow part around the longitudinal axis of the steering shaft 102. The dome-like supporting body 109 is pivotably mounted to the housing 101 around an at least essentially vertical axis. The supporting body supports the steering shaft 102 in an upright position during any functional movement of the steering shaft 102. With a supporting means such as the supporting body 109, the steering shaft and the gripping frame 103 are supported so that a user does not need to support the steering shaft themselves. To achieve the rotational guidance, the dome-like support body 109 has a cylindrical aperture having a ring flange 115 which is guided in a corresponding guiding arrangement of the housing 101. The upper part of this guiding arrangement is a covering ring 116 which is fixed to the housing 101. The rotational movability of the dome-like supporting body 109 can be seen in FIG. 12.

The buckling joint 105 comprises a cardan joint part 113 which is in one piece with the cylindrical part which extends into the joint shank 108. The buckling joint also contains the shaft joint part 112 which is fixed to the steering shaft 102 and which is pivotably mounted to the cardan joint part 113 around a buckling axis 114 which is perpendicular to the longitudinal axis of the steering shaft 102. The buckling joint allows the pivoting of the steering shaft 102 around the buckling axis 114, which brings the steering shaft 102 into a transporting position, which saves storage space. In the transporting position, the steering shaft 102 is pivoted to the front end of the lawnmower and not away from the lawnmower to the rear side, as is the case with known arrangements.

Referring now to the function of the steering device, a pivoting of the gripping frame 103 around the longitudinal axis of the steering shaft 102 will automatically lead to a turning movement of the dome-like support body 109 around the vertical rotational axis of the housing 101. To the same extent, the central cardan element 107 is forced to a pivotable movement around the stationary longitudinal axis 111. A turning of the gripping frame 103 around the longitudinal axis of the steering shaft 102, therefore, automatically leads to a horizontal movement of the steering shaft 102 to one side around the vertical axis of the housing and of the dome-like support body 109. The steering shaft 102 can be pivoted or moved around the vertical axis of the housing 101 completely through 360°, however, in practice the steering shaft is typically pivoted through around 45°. With the present embodiment this is equivalent to a rotation of the gripping frame 103 around the longitudinal axis of the steering shaft 102 with a corresponding angle.

1. A traveling soil cultivation appliance comprising:
a housing for receiving cultivation elements; and
a guide mechanism which can be handled by an operator and which is pivotably located on the housing with respect to an axis substantially vertical to the cultivation plane,
wherein the guide mechanism is provided with a rotatable steering device, whose rotary movement at or in the housing can be converted into a torque about a vertical axis,
wherein the steering device comprises a steering shaft with a steering wheel or steering frame,
wherein the steering shaft is articulated to a bearing body connected to the housing, the articulation provided by a universal joint.

2. The soil cultivation appliance according to claim 1, wherein the steering device is surrounded by supporting means which support the steering shaft in an upright position during any functional movement of the steering shaft.

3. The soil cultivation appliance according to claim 1, characterized in that the steering shaft is constructed as a telescopic shaft.

4. The soil cultivation appliance according to claim 1, further comprising a buckling joint which allows the pivoting of the steering shaft around a buckling axis to bring the steering shaft into a transporting position.

5. The soil cultivation appliance according to claim 1, wherein the universal joint comprises a longitudinal pivot axis that extends horizontally.

6. The soil cultivation appliance according to claim 1, characterized in that the steering shaft is oriented under a predetermined angle to the cultivation plane or to a plane parallel thereto and on the housing is fitted to a bearing body, which is mounted in the housing so as to pivot about the vertical axis.

7. The soil cultivation appliance according to claim 6, characterized in that the steering shaft traverses the bearing body and acts with at least one offset on a support surface of the housing, which is located at least in a direction parallel to the cultivation plane at a distance from the bearing body.

8. The soil cultivation appliance according to claim 7, characterized in that the support surface is part of a guide casing for the bearing body held in fixed manner in the housing and which forms a shaft with side walls oriented parallel to the direction of travel of the soil cultivation appliance and which serve as support surfaces.

9. The soil cultivation appliance according to claim 8, characterized in that the offset of the steering shaft is constructed as a laterally projecting arm provided at its free end with a slider guided on both side walls of shaft.

10. The soil cultivation appliance according to claim 9, characterized in that the slider has an axially symmetrical construction.

11. The soil cultivation appliance according to claim 9, characterized in that the slider is fitted in rotary manner to the arm.

12. The soil cultivation appliance according to claim 1 characterized in that on the end facing the housing, the steering shaft is provided with a bevel gear, which cooperates with a corresponding toothed disk fixed to the housing.

13. The soil cultivation appliance according to claim 1, characterized in that the steering shaft is constructed as a flexible shaft.

14. The soil cultivation appliance according to claim 13, wherein the flexible shaft is guided in a support body pivotable about a vertical axis.

15. The soil cultivation appliance according to claim 1, wherein the housing is provided with front and rear wheels and that the vertical axis is located between the front and rear wheels.

16. The soil cultivation appliance according to claim 15, wherein the spacing of the vertical axis in the longitudinal direction of the housing is less than 30% of the spacing between the rear and front wheel axes.

17. The soil cultivation appliance according to claim 16, wherein the front wheel arrangement has one or two casters.

18. The soil cultivation appliance according to claim 16, wherein the wheel arrangements are not steerable and the contact surfaces of the wheels have a limited sliding resistance with respect to lateral displacement.

19. The soil cultivation appliance according to claim 1, characterized in that the guide mechanism is removably fitted to the housing.
